(19) United States
(12) Patent Application Publication
(10) Pub. No.: US 2024/0346912 A1
(43) Pub. Date: Oct. 17, 2024

(54) PERSONAL SECURITY ALERT DEVICE AND MONITORY SYSTEM

(71) Applicant: Andrew J Leahy, Riverton, NJ (US)

(72) Inventor: Andrew J Leahy, Riverton, NJ (US)

(21) Appl. No.: 18/135,734

(22) Filed: Apr. 17, 2023

(51) Int. Cl. G08B 25/01; H04W 8/20

(52) U.S. Cl. CPC G08B 25/016; H04W 8/205

(57) ABSTRACT

A personal security alert and monitoring device transmits information to a third party either by simple pressing of a button when the user experiences an emergency situation, or by automatically detecting changes in material parameters such as heart rate, blood sugar, ambient temperature and physical forces such as rapid acceleration or deceleration. Sensors carried by the device are capable of detecting one or a variety of important parameters. The device is portable, preferably of the size and form of a handheld, rectangular and elongated form factor with a prominent emergency alert button prominently located near one of the ends of the device. Significantly, the device includes an eSIM card or cards capable of communicating through cellular networks across international borders. The device is capable of tethering to a cellular telephone or other computing device so as to permit voice and video reception and transmission. Miniaturized displays, speakers and input/output means can be included in in the personal security device.

### FIELD OF TECHNOLOGY

The invention relates generally to an apparatus and method for providing personal security and monitoring services, and more specifically to embodiments of a monitoring device equipped to transmit location information, personal information, including health information, is able contact local authorities and transmit the information to the authorities in the event that assistance may be requested.

### BACKGROUND

Modern technology has brought us the capability to send and receive information wirelessly, over short and long distances. As technology has progressed, communication devices have become faster, more complicated, store more information and are able to include a vast number of features that allow individuals to communicate in many number of ways. Computing devices such as cellular phones, smart phones and tablets have become ubiquitous amongst the general population and can be vital in situations where assistance may be needed. These computing devices however have been designed with features that are almost exclusively used during non-emergency situations. Computing devices such as smart phones and tablets can suffer drawbacks that may make them inaccessible, when an emergency arises. For instance, cellular phones and tablets may be out of reach or have limited battery remaining when an emergency arises. These computing devices may also have complex interfaces that may make it difficult for individuals to find and access the appropriate features during a stressful emergency situation. Often, individuals who are untrained or unprepared for an emergency situation that arises, may suffer from an inability to properly communicate important details to emergency responders. Thus a need exists for a device that is easy to use, accessible and capable of providing the necessary information to emergency responders and third parties, even under the most stressful, dangerous and intimidating situations.

### SUMMARY

A first aspect of the present invention is an apparatus which includes a data storage device capable of retaining information of at least one of personal identification information, location information, health information, video, audio and environmental information, a radio transmitter capable of transmitting the information to a third party, and a button capable of activating the radio transmitter.

Another aspect of the present invention is to provide a method for requesting assistance which includes the steps of providing a monitoring device having a radio transmitter, storing information on the monitoring device including at least one of personal identification information, location information, health information, video, audio and environmental information, and activating the monitoring device, wherein the step of activating includes transmitting the stored information to a third party and opening a direct line of communication with the third party.

Yet another aspect of the present invention includes a method for requesting assistance which includes the steps of providing a monitoring device having a radio transmitter, storing information on the monitoring device including at least one of personal identification information, location information, health information, video, audio and environmental information, networking the monitoring device to a computing device having access to a network, accessing one or more components of the computing device, and transmitting the information stored on the monitoring device to a third party via the network accessible by the computing device.

Another aspect of the present invention is to provide a personal security alert system which includes a portable device having memory sufficient to retain personal data of a user, including at least one of the user's personal identification information, location information, health information, video, audio and environmental information, where the portable device is adapted to send and receive the information and having an eSIM card capable of communicating with a telecommunications network located in the United States and at least one other nation state. The system further includes a base station adapted to send information to, and receive information from, the portable device, and being configurable to monitor an alert condition indicated by at least one of a manual actuation of an alert switch actuated by the user and a sensed medical parameter automatically transmitted by the portable device, the alert condition being transmitted to the base station. Further provided is an application, loadable on a computer, and providing a user interface capable of making user settings and entering user personal data, the user settings including at least one of multiple call processing options, a primary emergency call location, a secondary emergency call location, a law enforcement call location, and a private security call location.

A further aspect of the present invention is to give the portable device an optimal form factor for use in an inconspicuous way, in a size that is not only compact but easily held, easily reached, and easily actuated so as not to indicate to an attacker, for example, that the user has notified private security, police, or other stored contacts that help is needed. The device is constructed to have many of the features of a cellular phone, including an eSIM card or cards to facilitate cellular communication in multiple coding formats in use in multiple countries, and a GPS chip or chip set to provide tracking, geo-fencing, and location indications as part of an emergency event indication. The GPS capability also allows the device to be found, if lost, by broadcasting its location when properly queried for location.

The form factor of the device is preferably of a rectangular casing about 93 mm long, 32 mm wide, and 13 mm thick, with the emergency activation button located near one of the ends of the casing. In this form, the device provides an optimum of the following: space for internal parts (circuits, chips, battery, etc.), slim profile to hang on a belt loop or purse strap, or fit in a pocket without noticeable projection, or to be simply handheld while being substantially obscured by the hand. The ideal is to have the user be able to manipulate the emergency activation button without being noticed.

### BRIEF DESCRIPTION OF THE DRAWINGS

The details of the present invention, both as to its structure and operation, can best be understood by referring to the accompanying drawings, in which like reference numbers and designations refer to like elements.

FIG. 1a depicts a top view of a personal monitoring apparatus;

FIG. 1b depicts a front view of the embodiment of FIG. 1a;

FIG. 2 depicts an embodiment of a personal monitoring apparatus requesting assistance;

FIG. 3 depicts an alternate embodiment of a personal monitoring apparatus requesting assistance via a tethered computing device;

FIG. 4 depicts an embodiment of a personal monitoring apparatus requesting assistance via communication with a second personal monitoring apparatus;

FIG. 5 depicts a schematic of a method for requesting assistance using a personal monitoring apparatus;

FIG. 6 depicts an embodiment of a user interface for tracking and determining the position of a personal monitoring apparatus;

FIG. 7 depicts an alternative embodiment of a user interface having a message board and onboard communication services capable of contacting users of other personal monitoring apparatuses;

FIG. 8 depicts an embodiment of a method of relaying the position of a personal monitoring apparatus to a computing device capable of tracking or ascertaining the apparatus's location;

FIG. 9 depicts an embodiment of a method for triangulating the position of the apparatus via three or more cellular network towers;

FIG. 10a depicts a short range method for tracking the position of personal monitoring apparatus using wireless transmitter such as Bluetooth;

FIG. 10b depicts a short range method for tracking the position of a personal monitoring apparatus using a radio transmitter to activate onboard lights, sounds and other stimuli to alert the user to the position of the apparatus;

FIG. 11 is a front side perspective view of a preferred embodiment of a hand-held personal security alert device according to a preferred embodiment of the present invention;

FIG. 12 is a front, opposite side perspective view of the alert device of FIGS. 11; and

FIG. 13 is an exploded view of the alert device of FIGS. 11 and 12.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. The figures, in some cases, show overlapping components in assembly. The overlap is illustrative of an interference fit in which the components flex or otherwise accommodate the assembly of the components.

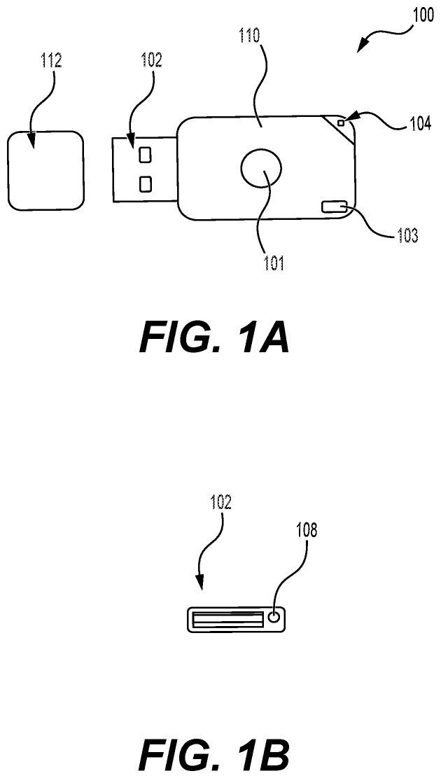

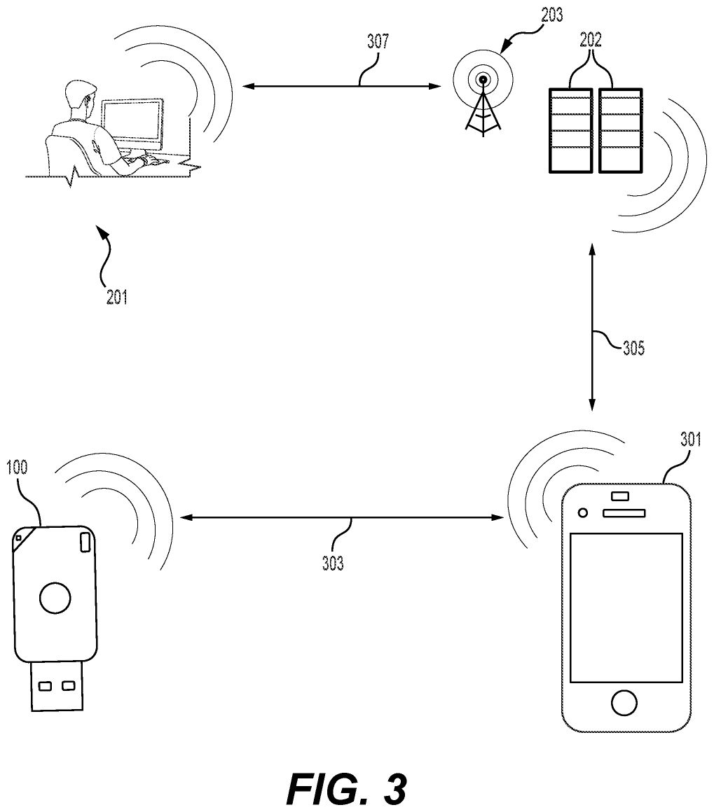

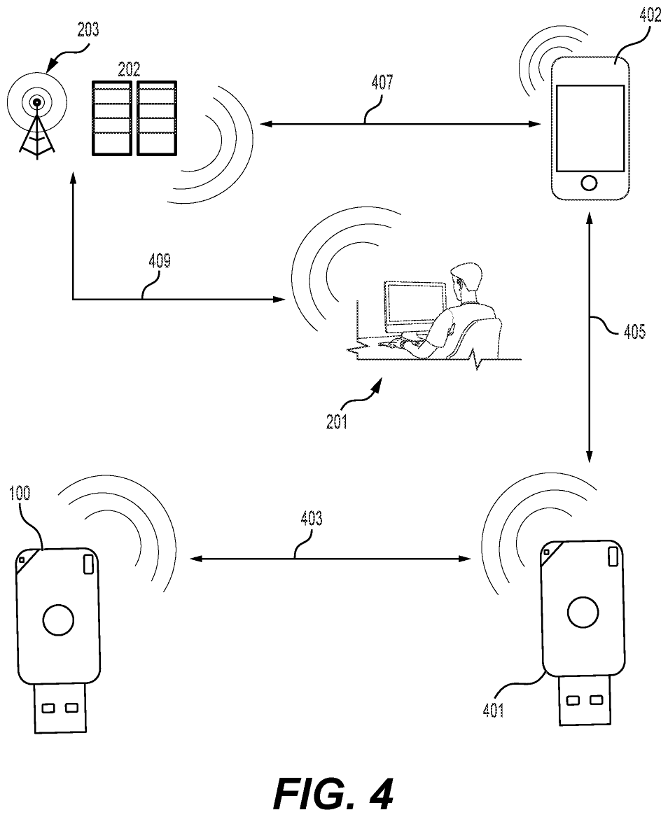

Referring to FIG. 1a, which depicts an embodiment of a personal monitoring apparatus 100. The personal monitoring apparatus 100 may be any type of data storage device 110 which may record, store, transmit or communicate information and data to a third party, a second monitoring apparatus 401 (FIG. 4) or a computing device 301 (FIG. 3). Information that may be communicated may include information describing the owner or current user of the apparatus, their physical description, their location, a picture of the owner or current user, their address, contact number, student ID number, any general information about the user's environment or the nature and reasons for the transmission of the information to the third party, including descriptions of the surrounding environment, including hazardous conditions and details that may be pertinent for an emergency response.

In the event of an emergency or an event requiring assistance, an individual user may readily request assistance from emergency services or other third parties registered on the apparatus 100 by activating the personal monitoring apparatus. The apparatus 100 may be designed in some embodiments to be simplistic and easy to use so that when a situation arises, an individual may easily request assistance as quickly and effortlessly as possible. In some embodiments, the personal monitoring apparatus 100 may engage a sequence of steps requesting assistance through manual activation by the user. For example, in the exemplary embodiment of the apparatus 100, the monitoring apparatus may be equipped with a button 101, switch, slider or other mechanism controlled by the user. In whatever form, the mechanism is mechanically easy to activate, such as by pressing, translating, rotating or other motion, with a finger. Once activated, the button activates circuitry to broadcast a signal requesting assistance. Upon activating the button, switch, slider or other activation mechanism, a request for assistance may be broadcasted to a third party wherein said broadcasted request may include information such as location of the user (by GPS or other position determining means), user identifying information, environmental details or conditions and further details about the nature of the request and the type of assistance needed.

In some embodiments of the apparatus 100, the apparatus may be configured to alert emergency services such as fire departments, ambulances, police, poison control or other third parties registered and stored in the memory of the apparatus 100 such as a contact person, relative or physician. In some embodiments, the third party contacted may vary depending on the nature of the assistance required. For example if the person is threatened on a college campus, the apparatus may be instructed to contact campus police as the third party. In another instance, there may be a fire and thus the apparatus may request that the local fire department dispatch fire personnel to the location at or near the location of the apparatus 100. In other instances there may be health related issues or emergencies that would necessitate that an ambulance may be necessary. The device 100 may be capable of storing multiple third parties to contact in the memory of the apparatus. In some embodiments, the user may be able to select or designate which type of assistance may be needed and whom to contact under the specific current conditions. In other embodiments, the apparatus 100 may include only a general request for assistance by contacting the local 911 dispatcher, based on the current location information of the apparatus.

In alternative embodiments, the apparatus 100, may be equipped with one or more sensors 103. The one or more sensors 103 may be used to automatically track and monitor various user based variables or environmental conditions surrounding the apparatus. For example, in some embodiments, the sensors 103 may be equipped to monitor and track medical and health related variables of the user such as heart rate, blood sugar levels (for example, if the user is diabetic), pulse rate, breathing rate, body temperature, or any other medically measurable variables.

In the event that a monitored variable increases or decreases above a certain level, the sudden change in the monitored variable may indicate an event that requires assistance such as emergency medical assistance. For example, if heart rate is being monitored by a sensor 103 and the monitored heart rate spikes unexpectedly to a predetermined level, such as 200 bpm, this may indicate that there may be a blockage or embolism causing the heart to work harder than normal, which may ultimately lead to a heart attack. Accordingly, in response to the observed symptoms measured by the monitoring apparatus 100, the apparatus may automatically initiate contact with services that may be capable of assisting with the associated medical condition. Such services may include contact an ambulance, the user's primary care physician and a local hospital.

In another example, the monitoring device may be monitoring the user's body temperature. The user's body temperature may begin to increase or decrease to a level that may not be considered normal. For instance, the body temperature may rise over normal human body temperature of 98.6° F. This may indicate the individual is suffering from a fever or other condition that may require medical attention. The apparatus may be programmed to respond to a spike in body temperature by contacting the user's physician who may have contact information registered and stored on the apparatus 100. In another example, the body temperature sensor may detect an unsafe drop in body temperature. This may indicative of hypothermia. Accordingly, the apparatus 100 may automatically contact a third party to request assistance, such as the fire department or an ambulance.

In alternative embodiments, the sensors 103 may be capable of measuring the environment around the user and activating a request for assistance based on the sudden measurable change in the environment surrounding the user. Environmental factors such as ambient temperature, acceleration, velocity, and even a predetermined list of key words or sounds may provide clues regarding the need for emergency assistance may be used to activate a request for assistance from a third party. For example, embodiments of the sensor 103 may measure the surrounding ambient temperature of the user. In the event of a fire, the user may be either unconscious due to smoke inhalation or sleeping and therefore unable to engage the request for fire services by manually pressing the button or switch 101. The sensor 103 may detect a sudden extreme increase in temperature surrounding the device and automatically alert fire services that a hazardous heat based condition may exist such as a fire. The apparatus may further assist the fire services by providing location information and identifying information about the user so that the user may be found and identified by the fire department quickly.

In another embodiment, wherein the monitoring apparatus 100 includes one or more sensors 103, the monitoring apparatus may record and track the velocity or acceleration of the user using an accelerometer. The velocity or acceleration may be indicative of the user's mode of transportation, such as being in a vehicle, on a bicycle or just walking on foot. However, sudden spikes in acceleration or a sudden decrease in velocity, beyond the rate of a standard braking system, may be indicative of a collision between vehicles or the user being struck by a vehicle. Accordingly, in response to a sudden change in acceleration or velocity, the apparatus 100 may automatically engage services or assistance to respond to the user's current location, or the device may open a dialogue with the user to inquire whether the user is unharmed or in need of assistance.

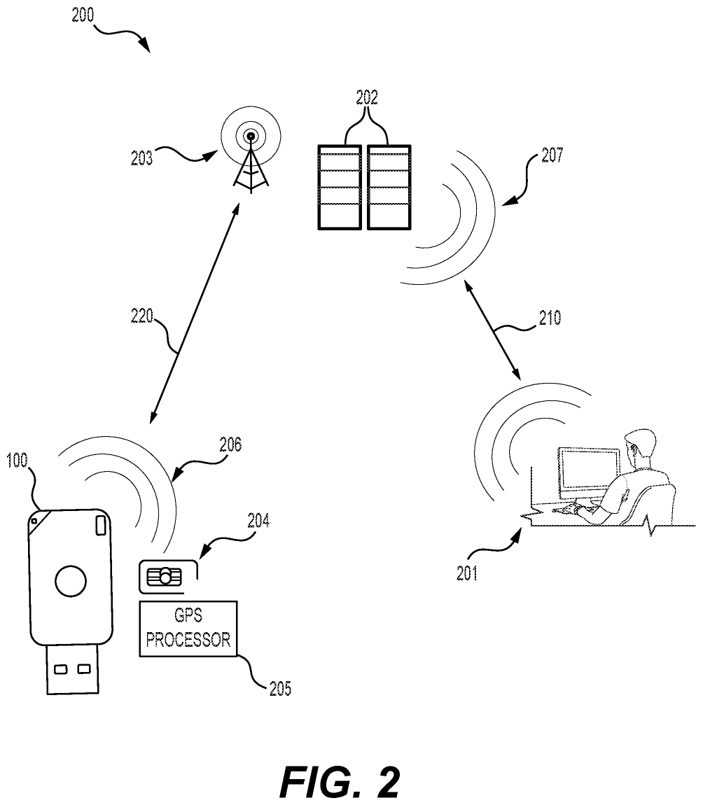

Embodiments of the apparatus 100, may include a data storage device having a flash based memory storage device such as a Universal Serial Bus (USB) flash drive form factor 102. In some embodiments, the apparatus 100 may include a subscriber identity module (SIM) such as a SIM card 204 (FIG. 2) found in mobile network devices such as cellular telephones. In some embodiments, the SIM card 204 or other SIM device may be integrated with the data storage device 110. In embodiments including a SIM card 204, the SIM device may store subscriber identification information or related keys which allow the apparatus 100 to access and/or be identified on a mobile communications network.

The SIM card 204 may be controlled by a logic board housed within the personal security apparatus 100. The apparatus 100 may be configured to utilize the SIM card 204 and the SIM card's identifying information to send and receive mobile communications on a mobile communications network. Embodiments of the monitoring apparatus 100 are able to send and receive communications between the servers of communications networks. The personal monitoring apparatus can communicate with any known communications network in which the apparatus 100 may be configured to communicate with including, Global System for Mobile Communications (GSM), General Packet Radio Service (GPSR), and Short Message Service (SMS).

The personal monitoring apparatus 100 may include, in some embodiments, a Global Positioning system (GPS) module 205. The module 205 may be capable of transmitting, receiving and storing information regarding geographical location of the apparatus 100 via the GPS satellites orbiting above the Earth. In an alternative embodiment, the apparatus 100 may include an Assisted GPS (AGPS) module. The AGPS module (in the drawings, a substitute for module 205) may download orbital information from the GPS satellites and store it in a database on the data storage device 110 of the apparatus 100 using a mobile communications network such as GSM, CDMA, WCDMA, LTE or even using a radio based network such as Wi-Fi to send and receive the positioning data in less time than a GPS alone.

GPS modules and accompanying circuit components are commercially available with varying specifications. Examples include the NEO-M9N module which includes a 92-channel u-blox M9 engine GNSS receiver, which allows reception of signals from GPS, GLONASS, galileo, and BeiDou constellations with approximately 1.5 meter accuracy. Complete boards for GPS modules can be incorporated into the circuit board within the apparatus 100.

In some embodiments, the personal monitoring device is equipped with a radio transmitting device. The radio transmitting device may be used to send and receive signals between one or more personal monitoring devices 100, one or more computing devices, one or more computing networks, or other devices capable of receiving radio transmissions. Embodiments of the radio transmitting device may include transmitters and receivers for Bluetooth, Wi-Fi, Bluetooth low energy (BLE), RFID, CDMA, GSM, or any other known type of wireless radio devices capable of transmitting a signal, or combined radios for multi-mode reception and transmission.

Referring to FIG. 1a, embodiments of apparatus 100 may further include a power source such as a battery. The power source may be rechargeable or non-rechargeable. In one embodiment, the power source may be a lithium ion battery. As an alternative, or as a supplement, the apparatus 100 may be equipped with a port capable of connecting an external power supply or battery charger. A charger, once connected, may begin recharging the internal power source. In the exemplary embodiment, the apparatus 100 may be a USB form factor having a USB interface plug 102. The USB plug may draw power from a device such as a computer once it is connected, in order to recharge the internal power source. In yet another embodiment, the apparatus 100 may further be capable of accepting an alternate power supply such as charger inserted into an outlet. In some embodiments, once the USB plug 102 is inserted into a computing device, a user can download or store information on the data storage device 110. Such stored information may include GPS information, updated firmware, maps, personal identification information or any other files. Examples of information that may be stored and later transmitted by the apparatus may include identifying images of the user, name of the user, address, telephone numbers, student identification number, social security number, health insurance id number, lists of one or more personal physicians and their contact information, preferred hospitals, known allergies and conditions, names and locations of parents, spouse, significant other or additional third parties that may be contacted in the event of an emergency.

Referring to FIG. 1b, some embodiments of the apparatus 100 may contain a power source indicator 108. The power source indicator may be a light such as an LED. The power source indicator may light up, flash or change colors to indicate the status of the power source. For example, the power indicator may identify the apparatus as being fully charged, charging or low on energy. In some embodiments, the apparatus 100 may also include a small display screen to indicate the amount of remaining power left in the power source.

Embodiments of the apparatus 100 may also include additional features such as a key ring or chain port 104 for allowing the apparatus to be attached to another object. For example, the apparatus 100 may be placed on a key ring, an article of clothing or any other item that is normally carried on the individual. This may allow the apparatus 100 to be readily accessible or nearby allowing for quick activation in the event of an emergency.

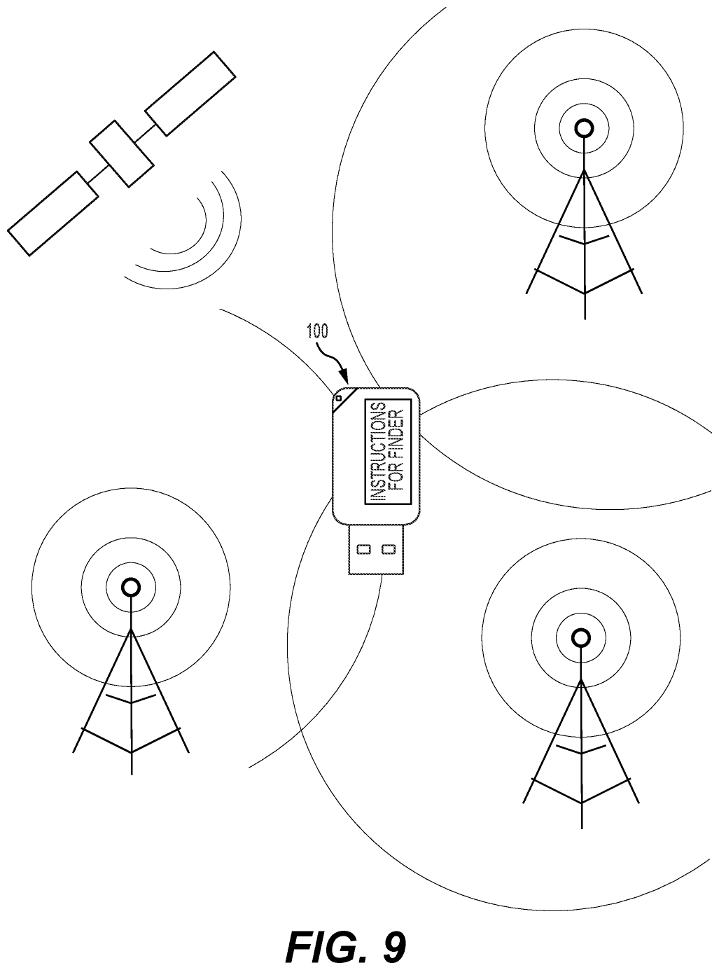

Other features of the apparatus may include an instructional portion alerting an individual non-owner of the found apparatus how to best communicate with the owner regarding the discovery of the lost item. The instructional portion may be a sticker, etching, LCD or LED screen or any other means affixed to the apparatus 100 for communicating with an individual who has found the apparatus, instructions for returning it to the proper owner. An instructional portion 106 (FIG. 9) may provide the owner's contact information such as an email address, telephone number, or physical address wherein they can be contacted. The apparatus 100 may also include an apparatus-specific key code or serial number printed on it. This key code may be an identifying mark registered with the United States Postal Service (USPS), Federal Express, United Parcel Service (UPS) or any other common shipping carrier. The instructional portion 106 may also simply instruct a finder to place the apparatus in the nearest mailbox. The identifying serial number may point the shipping carrier to the proper address for delivery, ensuring that the owner receives the missing apparatus and any other attached object thereto.

FIG. 2. illustrates a preferred system and method for utilizing the monitoring apparatus 100. In the depicted embodiment, the monitoring apparatus 100 is provided with a SIM card 204, allowing the apparatus 100 to directly access a cellular tower of a cellular network 203 and interface directly with network servers 202 to transmit and receive requests by apparatus 100. The request may be submitted to the servers 202 in any format the servers 202 may understand. For example, the requesting device may submit the request via a web service to a server, such web services may include HTTP, HTTPS, Representational State Transfer (REST) and XML or combinations thereof. In the exemplary embodiment depicted, the personal monitoring apparatus 100 may contact a third party 201, such as a dispatcher for emergency service by directly requesting the assistance once the apparatus is activated. The apparatus may be activated, for example, by the user engaging device such as by a push button 101, or automatically by one or more sensors 103 detecting that assistance may be needed. Upon being activated, the apparatus 100 may transmit 206 a signal 220 to a network server 202. Information included in the signal 220 may include personal information about the user stored in the apparatus 100, location information obtained from the GPS module 205, voice or video data from the user describing the current situation and details describing why the assistance may be needed and/or any information obtained by the sensors 103 that may be useful to the recipient third party of the request.

Once a server 202 has received the request from the apparatus, the server may prepare and send a message via a mobile communications network 203. The request by the apparatus may include identifying information including information for the SIM card 204 that the server can use to communicate via a mobile network. The communicating network 203 may send the message via any mobile communications network the SIM card may be identifiable on. Communications networks 203, which may be used to communicate, may include GSM, GPRS and SMS communication networks or similar networks.

The requests made to the server by the device 100 may then further be broadcasted 207 to a third party 201 via a second signal 210. Upon receiving the request for assistance, the third party 201, such as an emergency services dispatcher, may view the received information, which may include personal information and location data submitted by the apparatus. The third party may proceed to open a line of direct communication with the apparatus 100 and communicate with the user directly in an effort to ascertain more information about the current situation. For example, in some embodiments of the apparatus, the apparatus may be equipped with an onboard microphone, on board video camera and/or an onboard speaker. This may allow the third party to speak directly with the user or view the user's surroundings first hand. In some embodiments, the apparatus may record the conversation between the third party 201 and the user. The conversation may be stored in the storage device memory of the apparatus 100. A third party 201 may also use the location data received to find the closest video source such as a CCTV camera that can be accessed, in order to identify additional details of the situation relating to the request for assistance. Accordingly, the third party may also use the location data of the apparatus to target a response and request that additional assistance be sent to the apparatus's location.

In some embodiments, the apparatus 100 may not include each and every feature of the embodiments described. For example, the apparatus 100 may not include such features as a GPS processor, SIM card, a camera, a microphone, or one or more speakers. Embodiments of the apparatus however may be tethered or connected to a computing device 301 (FIG. 3) and the apparatus may be able to co-opt and utilize the computing device's onboard functionalities instead of having them directly equipped on the apparatus 100 itself. Examples of a computing device 301 that may be connected to or tethered with the apparatus 301 may include but are not limited to cellular phones, home computers, laptops, table computers, smart phones, video game systems, smart televisions, or any network enabled device. The network between the apparatus 100 and the computing device may be established wirelessly. The apparatus 100 may in some embodiments utilize its onboard radio transmitter such as Bluetooth, Wi-Fi, and Bluetooth LE, described above, to establish a network connection with the computing device 301. The connection may be established using any network protocol known, including TCP, IP and TCP/IP protocols.

Once a network has been established between the personal monitoring apparatus and the computing device, the apparatus may co-opt and use the personal computing device 301 to send and receive information in a manner as if the additional components of the computing device 301 were built into the apparatus 100. For example, the apparatus may take advantage of the personal computing device's onboard GPS processor, microphone, SIM card, camera, speakers, and other features.

In some embodiments, the computing device 301 may have an application or program loaded onto the computing device that may allow the user to regulate, control and determine which features and settings of the computing device may be controlled by the apparatus 100. The user of the apparatus and the personal computing device may set permissions for the apparatus, allowing one or more features to be co-opted by the apparatus. In some embodiments, the application or program may be a standalone program having its own graphical interface. In other embodiments, the application or program installed onto the personal computing device may be an application programming interface (API) loaded into an existing software or hardware component on the personal computing device. The API may contain instructions and programming directing an existing piece of software or hardware how to interact and respond to communications sent to the device by the apparatus 100. In some embodiments, apparatus 100 or the computing device may be customized with API's of third party products. For example, currently on the market there are companies that produce various sensor related fitness bands and health peripherals. The apparatus 100 or the computing device 301 may be loaded an API that can integrate the features of the third party peripherals into the apparatus 100. Using a fitness band as an example, companies such as Jawbone® and Fitbit® have wearable bracelets that monitor various conditions of human health and fitness. The parameters of the fitness band may be used as the sensors 103, in addition to, or in lieu of the onboard sensor of the apparatus. This may allow the user to add or remove sensors via third party products.

Furthermore, in some embodiments, the apparatus 100 may be able to identify and customize the information sent to the third party 201 in order to identify the source of the information received. For example, the apparatus may be capable of identifying and distinguishing which sources provide the data being sent to the third party. For example, the apparatus may identify in the information submitted to the dispatcher that the heart rate figures are obtained from a “Polar H6 Heart Rate Sensor” versus heart rate figures received from an integrated Fitbit® wrist band.

In the exemplary embodiment of FIG. 3, a personal monitoring apparatus 100 may tethered to computing device 301 via a wired or wireless connection 303. In the event that the apparatus 100 is activated automatically via sensor 103 or manually by the user, the apparatus 100 may take advantage of the personal computing device's 301 onboard SIM card, memory or GPS to send a request 305 to a server 202 directing the server to contact a third party 201. Similar to the previous embodiment depicted in FIG. 1, the embodiment of the apparatus 100 of FIG. 2 may also submit location information, personal information, voice data, and/or video data to the third party. The request sent to server 202 may be transmitted via a network such as a cellular network or other communications network via a signal 307 submitted to the third party 201. Upon receiving the communication from the personal computing device 301, that was initiated by the apparatus, the third party may open a line of communication with either the personal computing device directly or the communication sent to the computing device 301 may be relayed back to the apparatus 100.

The procedure for sending communications back and forth may vary depending on the components equipped on the apparatus. For example, if the apparatus has an onboard microphone, then the onboard microphone and speakers, the apparatus may act as a pseudo headset for the computing device 301, allowing the user to speak into apparatus and receive auditory communications of the third party, without having to use the computing device directly. For example, the computing device may remain closed or in the pocket of the user, as the user speaks into microphone and listens to the speakers of the apparatus, while at the same time, the computing device in the user's pocket receives the information from the apparatus and transmits the information to the third party 201. However, in another example, wherein the apparatus 100 lacks a video camera and the third party attempts to view video of the surroundings or user, the user may have to directly engage the computing device camera to allow the third party to receive a video feed.

In some instances, it may not be possible for the user of an apparatus 100 to send a signal to a third party 201 with the user's own apparatus or apparatus tethered to a computing device 301. Such a situation may occur in circumstances where the user's apparatus is unable to contact a third party 201 without engaging additional hardware. Examples where an apparatus 101 may be unable to contact a third party 201 without additional hardware or components may occur when a SIM enabled apparatus is out of range of a communication network, the apparatus 100 is unable to tether to a computing device (e.g., device 301 does not have any more power, is out of range, or lacks permissions or software to communicate with the apparatus 100), or the tethered computing device is outside of a network. Under such circumstances where the apparatus is unable to contact the third party 201 on its own, the apparatus may search for a second personal security and monitoring apparatus 401 (FIG. 4). Embodiments of the first 100 and second apparatus may communicate via the onboard radio transmitters or via a radio transmitter on a co-opted device 301 being used by the first apparatus 100. In the Exemplary embodiment, the connection 403 between the first 100 and second apparatus 401 may be facilitated by a Bluetooth, Bluetooth LE, or Wi-Fi connection. Once a connection has been established between the first 100 and second 401 apparatuses, the first apparatus may direct the second apparatus to contact the third party 201.

In the embodiments wherein a second apparatus 401 is forwarding signals from the first apparatus 100, the second apparatus may operate in a similar manner to the embodiments described above. For example, the second apparatus may be equipped with a SIM card and GPS locator or any combination of features previously described. The SIM enabled second apparatus may directly communicate with server 202 via the network 203 and facilitate a request for assistance directly to the third party 201. In an alternative embodiment, such as the embodiment depicted in FIG. 4, the second apparatus 401 may be tethered to a personal computing device 402 which may be unassociated with a computing device that may be tethered to a first apparatus. Accordingly, similar to the method described previously, the second apparatus 401 may receive personal data, location data and other information to be relayed to the third party 201. Upon receipt of the request for assistance and the data, the second apparatus connected via network signal 405, may use the second computing device 402 to submit the location data, personal information and request of the first apparatus 100, for assistance, to the third party. Accordingly, the recipient third party, such as an emergency services dispatcher, may subsequently open a line of communication with the second computing device 402, second apparatus 401, first computing device 301 or the first apparatus 100.

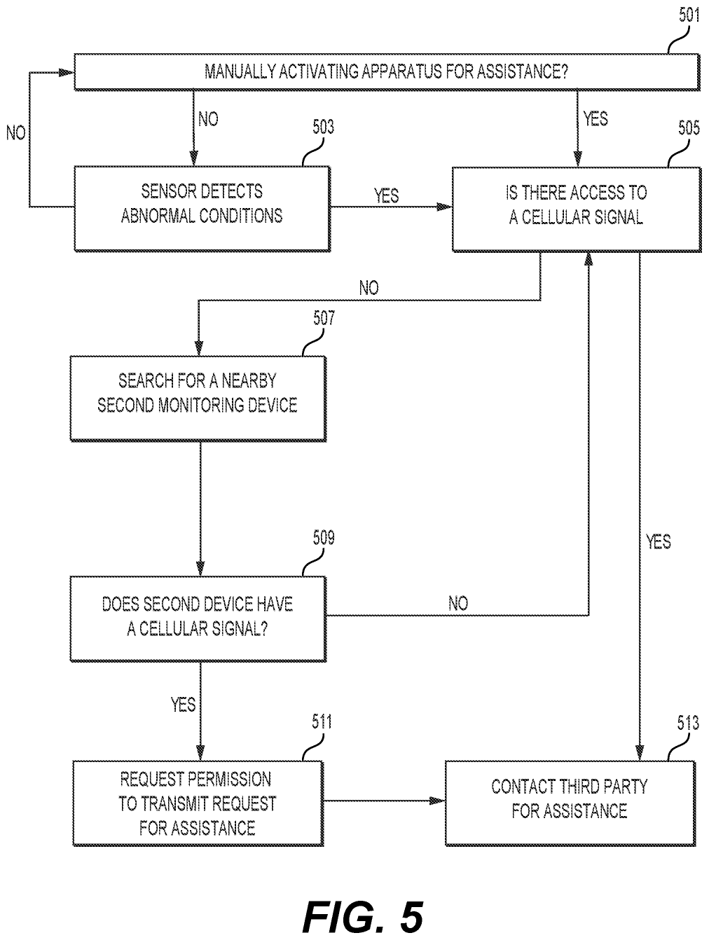

Referring to FIG. 5 which depicts a schematic of a method of activating and transmitting a request for assistance using an embodiment of a personal security alert and monitoring device 100. Embodiments of the method may include the steps of determining whether or not apparatus has been manually activated by the user 501. In the exemplary embodiment, the apparatus may engage in requesting emergency services or assistance by directly activating the button 101 on the apparatus itself. In the event that the apparatus has been manually activated by the user 501, apparatus 100 may subsequently determine whether or not assistance may be requested by the apparatus in its current state. This may include a step of evaluating the capabilities of the apparatus, including the step of determining whether there is access to a cellular signal 505 or other network capable of submitting the request for assistance to a third party. If a cellular signal or sufficient network is present 505, the apparatus may commence connecting to the network and submitting the request for emergency services 513 or other assistance via the network as described above.

In some embodiments, wherein a cellular network or signal is not directly available to the monitoring device 100, the device 100 may engage in a step of searching for and connecting to a second monitoring device 507. The apparatus may engage in a step of determining whether or not the second monitoring device is capable of sending the request for assistance or emergency service. If the second monitoring device is capable of forwarding the request, the first apparatus may request permission to send the transmission via the second apparatus and ultimately the second monitoring device may perform the step of forwarding the first apparatus's request for assistance, by contacting the desired third party. If however, the second apparatus does not have access to a network capable of requesting assistance or emergency services, the first apparatus may proceed by continuing to search for a separate device capable of fulfilling the request. In some embodiments, the first apparatus may also remain connected to the second apparatus and use the second apparatus to extend the searching range in order to find a third monitoring device within a search radius of the second monitoring device's radio transmitter.

In an alternative embodiment of a method for requesting assistance, the step of manually activating the apparatus may not occur. For example, the apparatus may not include a button, switch or other means for activating the apparatus manually, or the user may not have engaged in the step of activating the apparatus. In this alternative embodiment, the apparatus may engage in the activation step based on information collected by sensors detecting abnormal conditions 503. Based on the information collected by the sensors of the security apparatus, the apparatus may automatically elicit a request for assistance.

In some embodiments, the chain of personal apparatuses may be more than a first 100 and second apparatus. Embodiments may include a daisy chain of two or more apparatuses connecting to one another via radio transmitters one each device in the daisy chain. The chain may continue to grow in the number of devices connected, until an apparatus at the end of the chain is identified as being capable of communicating with a requested third party 201.

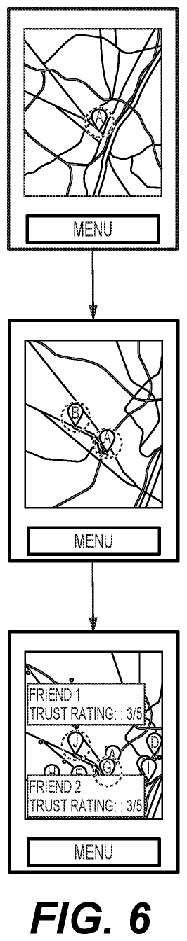

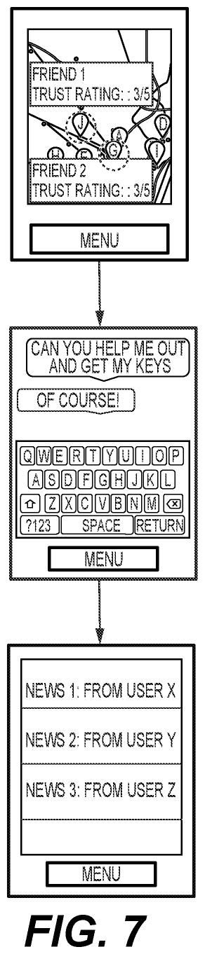

In some embodiments, the apparatus 100 may further be capable of having its position identified, located or tracked by a networked computing device. FIG. 6 depicts a user interface of a computing device tracking and determining the location of the apparatus 100. The user interface may be an application or program loaded on the tracking device. The tracking device may be any computing device capable of loading and running the application which communicates with the apparatus 100. Examples of a tracking device may include a personal computer, laptop, tablet PC, mobile phone, and network enabled media player such as an IPod. The tracking device loaded application interface may include a display portion. The display portion may include information regarding the location of the apparatus. In one embodiment, the location of the apparatus may be displayed on a generated map allowing for easy visualization of the apparatus's location. In an alternative embodiment, the tracking device may provide an address, and/or step by step directions guiding the user of the tracking device from their current location to the apparatus's location. The display generating the map, may follow the user's movements in real time and update the map depending on the user's location in relation to the apparatus 100.

In an alternative embodiment, the interface may provide on its display the locations of other users who have loaded the tracking interface for tracking their own apparatuses. The application interface may include a social network or community of active users who each have the interface loaded on their own tracking devices. The display of the interface may also include identifiers of each user. The identifiers may include a trust rating which users of the interface may comment about other users. The trust rating may be helpful in assisting individuals of the interface to determine which people are helpful in retrieving lost apparatus's or who may reliably give permissions to a user's apparatus when requests are made forwarding requests for assistance via a second apparatus 401. In some instances, a lost apparatus may be close to a user who is a member of the social network community of the interface application. Instead of making the trip to pick up a lost apparatus 100, an individual user may contact a community member who is close by and ask that they retrieve a lost apparatus for them. The trust rating may allow users to provide feedback regarding helpful and unhelpful users.

The user interface may further include communication functions and input mechanisms such as a keyboard, for facilitating communication between users of the interface application. In one embodiment, an individual attempting to ask another to retrieve their apparatus 100 may simply click the user profile on the display and then type a message and submit it to the user directly in the application interface. Users may then communicate back and forth to discuss the logistics of locating and returning the apparatus 100.

Alternative embodiments may include other forms of communication between users of the application, such as a message board. The message board may facilitate postings and responses between users of the application. The message board may be used to provide a mass request for assistance among the broad user base of the interface application rather than singling out and asking each individual user for a help. The message board may be useful for obtaining voluntary responses for help retrieving an apparatus.

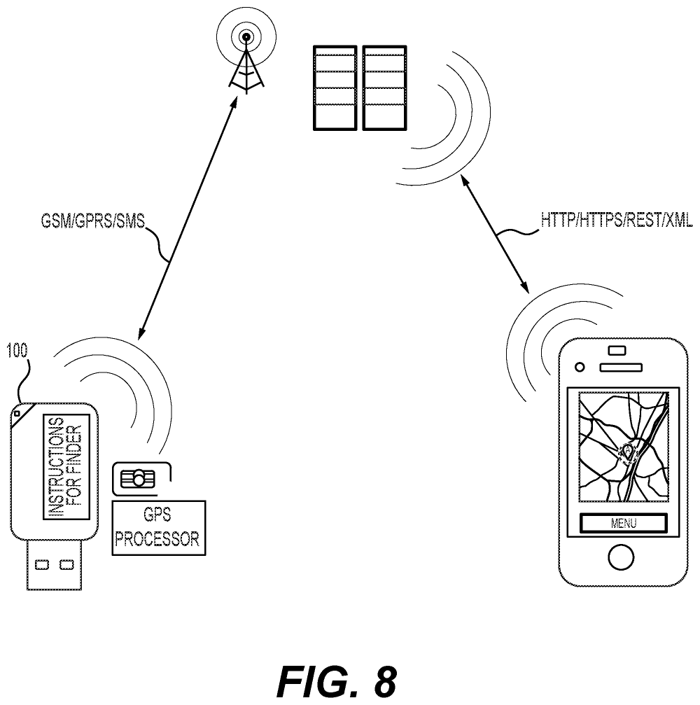

Referring to FIG. 8 which depicts an embodiment of a method for tracking and tracing the position of an apparatus 100. One embodiment may include submitting a request 601 from a requesting device 600 to a server 602. The request 601 may originate from a requesting device 600 capable of loading a graphical interface. The requesting device 600 may include any of the tracking devices previously mentioned including personal computers, laptops, tablet PCs, mobile phones, and network enabled media players such as an IPod. As pictured, the requesting device 600 acts as a tracking device submitting a request to the server. The request may be submitted to the server in any format the server may understand. For example, the requesting device 600 may submit the request via a web service to a server 602, where such web services may include HTTP, HTTPS, Representational State Transfer (REST) and XML or combinations thereof.

Continuing with reference to FIG. 8, once a server 602 receives the request from the requesting device 600, the server 602 may prepare and send a message via a mobile communications network. The request by the requesting device 60 may include identifying information including information for the SIM card that the server can use to communicate via a mobile network. The communicating network may send the message via any mobile communications network the SIM card may be identifiable on. Communications networks, which may be used to communicate, may include GSM, GPRS and SMS communication networks.

The apparatus 100 may receive network communication. The logic board within the apparatus 100 may upon the receipt of the message, query location information using a GPS module within the apparatus 100 from GPS satellites. Upon retrieval of location information the apparatus 100 may submit a return communication to the server 602 using the SIM card 404 along a communication network such as GSM, GPRS, SMS, CDMA, WCDMA, LTE, EDGE, 3G, 4G or even using a radio based network such as Wi-Fi.

Once the server 602 receives the communication from the SIM card, the server may transmit the location information to the requesting device 600. In one embodiment, the server may receive an SMS text message and display the SMS in an XML file which may be available via HTTPS. In an alternative embodiment, the server 602 may send a notification to the requesting device 600 using the application's internal communication service and/or REST/HTTPS. Once the requesting device 600 receives the transmitted location information, the requesting device may display the location information on the user interface's display of the requesting device 600.

FIG. 9 illustrates a long range tracking method of an apparatus 100. In this embodiment, the traceable apparatus 100 may be equipped with a GPS and/or an AGPS module. The GPS module and AGPS may enable the device to send and receive location information with the GPS satellite. Using GPS and AGPS positioning systems, the satellite may transmit the positioning data to the apparatus 100. The apparatus may store the locational information within its data storage device. Upon receipt of a request by a requesting device, the apparatus may submit the GPS location data to the requesting device by the methods described above.

In an alternative embodiment, the traceable apparatus 100 may be equipped with AGPS only. The mobile communications networks may use cell tower triangulation to identify the position of the SIM Card embedded in the traceable apparatus. As shown in FIG. 9, triangulation methods may include the use of at least one cell phone towers to locate the apparatus. Each cell phone tower 503 may broadcast a signal on its mobile communications network in order to ping the SIM card of the traceable apparatus 100. By using at least three cell phone towers a more accurate approximation of the apparatus's position can be made. The point where all three of the broadcasted signals intersect with the apparatus's SIM card, may indicate the position of the SIM card embedded within the traceable apparatus 100. In yet another alternative embodiment, a traceable apparatus 100 may be located using a combination of both GPS location services and cell tower triangulation methods.

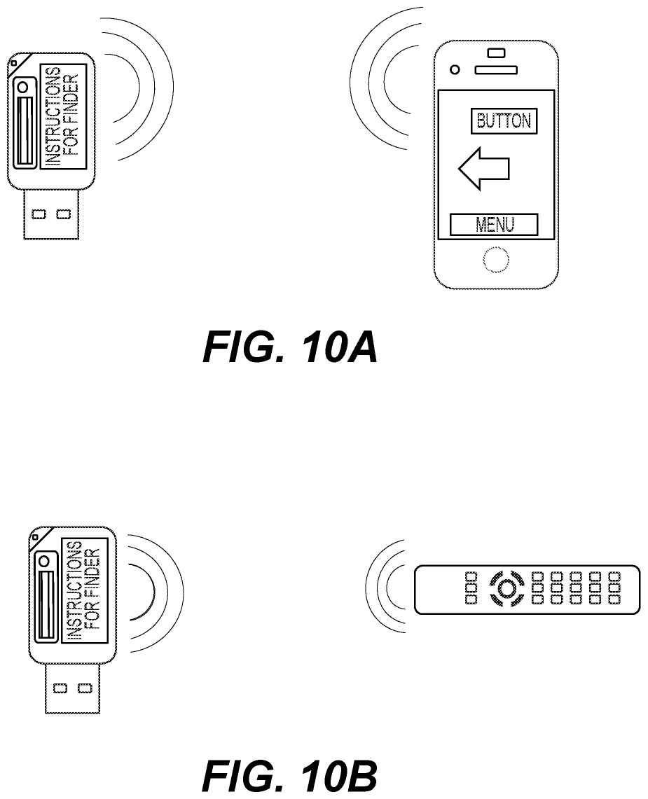

FIG. 10a depicts a method of short range tracking of an apparatus 100 using Bluetooth transmission. As previously described, the apparatus 100 may be equipped with a Bluetooth enabled transmitting device capable of sending and receiving Bluetooth signals 607. In one embodiment, a user may track the location of the apparatus 100 using a requesting device 610. The requesting device 610 may be equipped with a Bluetooth transmitter which may broadcast and ping the signal being emitted from the traceable apparatus 100. The requesting device 610 used to determine the location of the apparatus 100 may be equipped with an application which may display the current location of the apparatus 100. The application may also provide the user of the requesting device with turn by turn directions and other information which may aid the user in discovering the apparatus's location. In an alternative embodiment, the requesting device may communicate with the apparatus 100 via Bluetooth and remotely enable various output signals to be emitted from the apparatus's output device. Output signals may include flashing lights, sounds, vibrations and combinations thereof. In addition, the application may provide a menu of selectable output signals a user may select to enable directly from their requesting device. The requesting device may be able to adjust the volume and intensity of the output signals in order to aid their search of the apparatus 100 right from the application menu 605.

In an alternative embodiment, and with reference to FIG. 10b, the traceable apparatus 100 is equipped a radio frequency transmitter. The radio frequency transmitter may broadcast to, and receive radio signals from, a searching device 612. The searching device 612 may be any device capable of sending and receiving radio frequencies to and from the apparatus 100. A searching device may include remote control devices, requesting devices, personal computers, tablets, laptops, and mobile media players such as iPods. The searching device 612 may communicate with the apparatus 100 via radio frequencies and enable various output signals to be displayed from the apparatus's output device. Output signals may include flashing lights, sounds, vibrations and combinations thereof. In addition, the searching device may include buttons which may select the type of output signals released from the apparatus. The searching device may be able to adjust the volume and intensity of the output signals in order to aid their search of the apparatus.

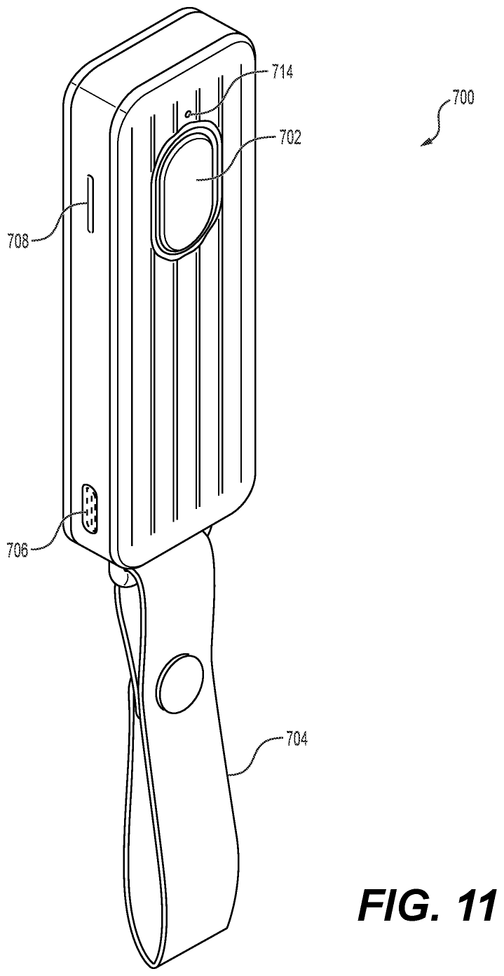

Referring to FIG. 11, a handheld personal safety alert device 700 of a preferred form factor and functionality is of generally quadrilateral shape. An emergency alert button 702 is positioned near one of the longitudinal ends of the device 700 at a location easily depressed by the user's thumb or forefinger, while held in the palm of the hand with the user's fingers curled around the device 700. The alert button 702 can be pressed, or alternatively, the button could be a switch moved between on and off positions, a knob easily turned between different positions, or any other physical structure when allows for manipulation by a single finger or thumb.

The requirement for easy manipulation or actuation is critical given the intended environment of use. For example, if a user is about to be attacked or otherwise senses immediate danger, the button 702 can be pushed while the device is readily at hand, as for example, when it is located in a pocket of the user, on the belt loop of the user by means of strap 704, or carried on the wrist of the user by means of the same strap 704. In such locations, the user can actuate the button without motion being detected by the assailant. Being of light weight and preferably of small dimensions, preferably 93 mm by 32 mm by 13 mm, the device 700 can be held in one hand by fingers, and actuated by the thumb while in the user's pocket or other location near at hand. The button 702 can be pressed a number of times, or held down for a predetermined period of time, to correspond to a programmed code indicating a particular event. For example, three presses of the button 702 can be programmed to signal an imminent life threatening situation. With the same button, a press and hold of the button 702 can be programmed to indicate other events, and similarly, pressing the button 702 a different number of times can be programmed to correspond to different events.

Further referencing FIG. 11, additional features of the device 700 include a USB port 706 for both charging the internal battery, or connecting an external battery, and for transferring data to and from the device 700. A speaker 708 provides verbal or audio coding communication in case the device 700 establishes a cellular communication via the eSIM card.

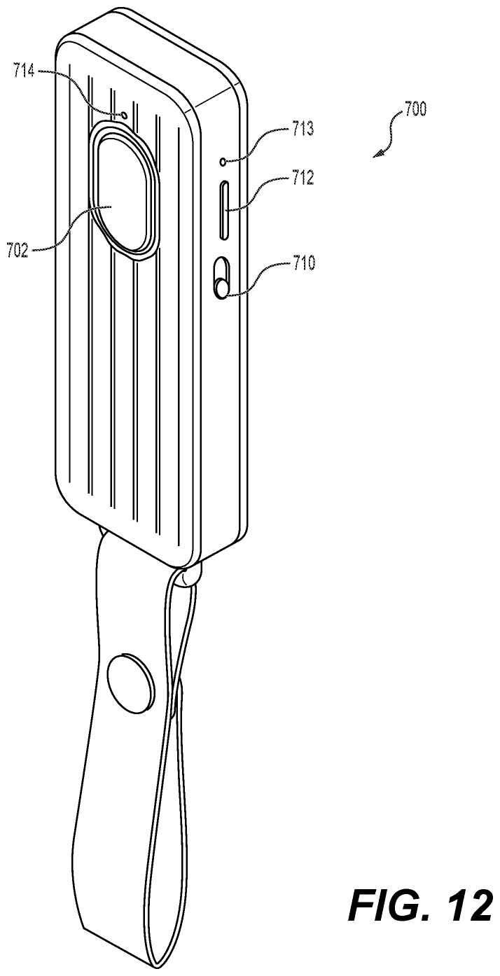

As seen in FIG. 12, device 700 may further include a power on/off switch 710, and an action button 712. The action button 712 initiates multiple functionality. For example, pressing and holding action button 712 can initiate a “fake call” whereby the user's cell phone rings as a way for the user to avoid talking to a person in the vicinity of the user. The call can be initiated by a signal sent through the wireless communication network to a server associated with a dispatch, call center or a monitor associated with a system of monitoring multiple devices 700. The fake call can also be initiated by the device 700 signaling the user's phone directly, either by calling the user's phone number via the eSIM cellular capabilities of the device 700, or by using a local wireless system such as a Bluetooth connection between the device 700 and the user's cell phone, causing the cellular phone to ring. The Bluetooth connection can be part of an application loaded onto the user's cellular telephone, which is also used by the user to configure the monitoring features that are unique to the particular user of the device 700,

The device 700 further includes a microphone 713 so that the device 700 can function to provide live verbal communication with a dispatcher, designated called party or parties, local security or law enforcement personnel, and/or 9-1-1 operators. In addition, a light 714 located above the button 702 indicates that the device is functioning, has sufficient battery power, or simply that the device is turned on. The light may be a particular color, e.g., blue, when functioning normally, or it may change color in the event that the battery needs charging or if the button 702 is activated.

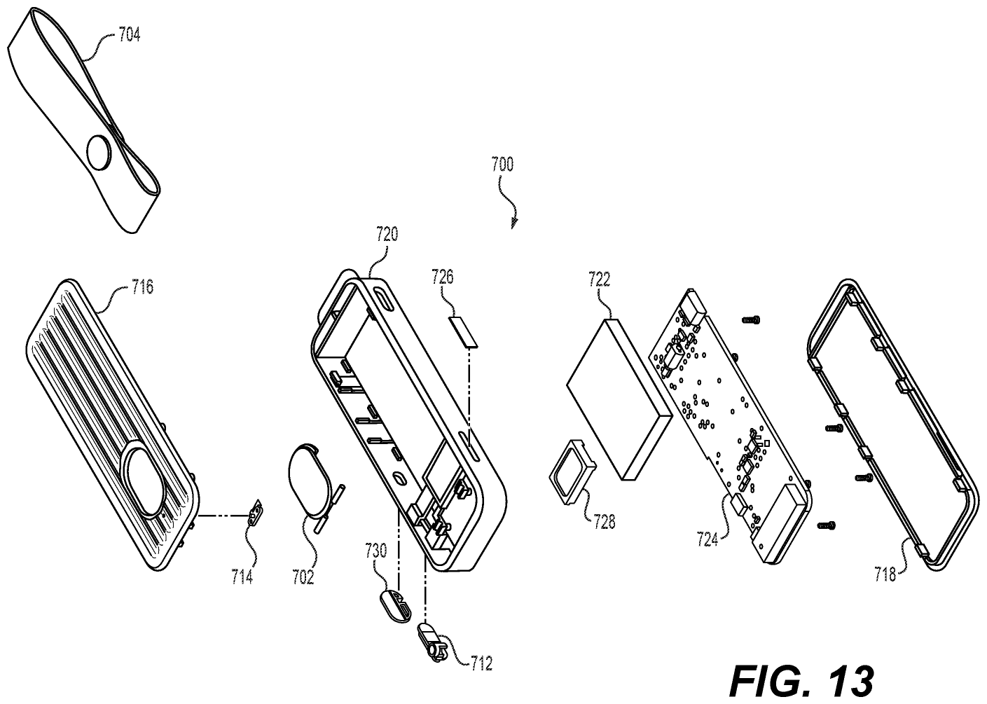

Referring to the exploded view of FIG. 13, the device 700 includes a button cover 716 having an opening through which the button 702 extends, and a front cover 718. A sidewall 720, when assembled, extends between the button cover 716 and the front cover 718 to define an interior space. The sidewall 720 is shown to be a rectangular sidewall with rounded corners and further shown to be a single continuous structure. While this reflects the desired form factor, the device 700 could have four separate sidewalls and non-rounded cornered shape, but the rounded corners are preferable for ease of fit into a user's desired placement.

The interior space of the device 700 houses the electronics and mechanical parts, which include a battery 722, a circuit board 724, speaker mesh 726, a speaker 728, the action button 712 and a mute button 730. Assembly screws are shown for holding the cover 718 to the circuit board 724, while the button cover 716 can be snap-fit or interference fitted onto the assembly. Chip sets provided on the circuit board 724 include at least an eSIM card or cards to permit cellular communication across national borders when the user is traveling between different countries that use different encoding schemes. Also, the chip sets include GPS chip sets for providing the location of the user as being automatically transmitted with an emergency event, such as when the button 702 is pushed by the user, or when a sensor automatically detects an emergency condition.

The circuit board 724 may also include connections to an accelerometer located inside the device 700. The accelerometer can be provide data indicative of a violent sudden stop (as with a car accident) or sudden acceleration (as when a user may have fallen or been hit by a person, vehicle or other object). When the accelerometer detects an acceleration or deceleration that meets a certain threshold, an alert can be sent automatically from the device 700 to a pre-programmed monitoring person or station, such as a relative, campus security or friend, or to 9-1-1. Alternatively, the device is part of a system which includes a monitoring service, where a dispatcher receives detected emergency events and can then initiate communication (verbal or video, if the device is provided with a camera, or if coupled to a phone with a camera by wireless connection such as blue tooth). In any event, the dispatcher will receive a GPS coordinate preferably in a mapping format so that help can be directed to the user.

A user can find a lost device 700 by using an application installed on a computing device by simply querying the location. A found device 700 can be returned to the proper user by referencing a sticker or other written information provided on the device.

The circuit board includes a processor and memory to storing data and programmed settings. By pressing the action button 712, and holding for a period of seconds, the user can initiate a “fake call” as a way of avoiding conversations with people in a crowd or elevator or any other location. By pressing the action button 712, either once or a number of timed depending on how the button pressing is coded, the user can excuse himself or herself from a conversation with a person, while appearing to answer a call.

Further programming and configuration can allow for geo-fencing, whereby an alert is automatically sent to a pre-programmed recipient if the person carrying the device 700 goes beyond a particular geo-fenced area, such as a school or college campus, or a preselected venue such as a movie theater, sporting event, restaurant, etc. The programmed recipient could be a parent, guardian, campus police, 9-1-1 call center or any other person or entity that can alert security or otherwise initiate help or assistance.

An important aspect of the present invention is the use of eSIM cards that allow cellular communication across international boundaries. Another aspect of the invention is that multiple users of devices 700 can be networked together via cellular, wifi, Bluetooth and any other wireless format to allow a community of users to communicate on selected wireless frequencies and encoding schemes. This is particularly desirable when the users are in a community of common interest, such as students on a common campus, military or law enforcement patrolling a particular location, base, building or other guarded space. An emergency event impacting one user can be communicated to other users of devices 700 so that the others can converge at the point of the emergency event, to assist the user or to apprehend a perpetrator. A key aspect of the invention is the ability to make non-verbal communications that are short and invocative of immediate assistance, such as a geographical near-by co-user of devices 700 grouped in a common chain, functioning as a mesh network, such that others that are alerted are aware of the event and can coordinate a response by communicating with each other. To save space and power consumption, the device 700 has no display and no keyboard. Verbal communication is possible, but only when a button is pushed or held. A channel of communication is opened by simple, inconspicuous movements of the thumb or a single finger.

A video camera (not shown) can be provided in the device 700 on the side opposite the emergency event button 702, to provide video feed during an emergency event. The video feed is transmitted by wireless networks to a base station, dispatcher or 9-1-1 call center, or to first responders to give current, real time data about the emergency event. Since emergency events do not occur often and regularly, it would not be an unnecessary drain on battery power to provide a camera and operate it during an emergency event.

Data transfer can be effected by use of the USB port 706 which can provide both power charging capability and data transport. Data transport allows for memory on board to store communications, verbal or video, at times when cellular connections are not available. The USB port 706 can also be connected to a computer device which is loaded with an application used to configure the device 700 and monitoring system. Through the application, the device 700 can be configured by having the user select emergency telephone numbers to call when certain events occur. For example, if the device 700 and thus the user go beyond a configured geo-fence, the dispatcher is notified by the device 700 and a pre-selected contact person or responder is contacted and notified of the geo-fence breach. To preserve battery power, the device 700 can be configured to transmit periodically geo-location using the GPS chip set, and a server or computing device locate at the dispatch or base station can use its computing power to track the transmitted location onto a map having fenced parameters. Thus, the server or computing device calculates and determines when the user goes beyond the geo-fence and then initiates a call to a predetermined party or parties. The device 700 can also process on board to determine if and when the device is outside a fenced area, and then transmit a call, SMS or any other type of communication to notify authorities, friends, 9-1-1 or any predetermined party or parties.

The device can also carry a satellite transmitter/receiver for sending short SMS messages when the alert button 702 is pushed, in the event that a cellular signal is not available. Satellite constellations in low earth orbit are available for such communications.

A “safety network” of individuals carrying devices 700 can be configured so that people in the network can talk in real time to report on emergency or other events. An example would be in a weather emergency, people within the group can report to each other on flooding, tornado sightings, storm surges in hurricanes, etc. In such situations, the safety network can operate by each individual pushing the emergency button and holding it down to permit live conversation on the cellular or other wireless communication networks. A “walkie talkie” type communication can occur as well, commonly known as push-to-talk over cellular (PTToC) where pressing and holding the button permits one to talk while the others listen, similar to VHF radio communications.

The system can be configured to allow others to see where the user is located by identifying the location of the device 700 on a map, using the GPS chip set. The location can be displayed on a follower's cellular phone or computing device. This is particularly useful when, for example, a child is leaving a venue to return home, and a parent can monitor in real time the progress of the child.

The button 702 is preferably covered with a reflective coating, to render it reflective, other otherwise provided with retroreflective material so that it can in the most simple form can act to reflect light of a first responder in a dark situation.

While this invention has been described in conjunction with the specific embodiments outlined above, it is evident that many alternatives, modifications and variations will be apparent to those skilled in the art. Accordingly, exemplary embodiments of the invention as set forth above are intended to be illustrative, not limiting. Various changes may be made without departing from the spirit and scope of the invention as defined in the following claims. The claims provide the scope of the coverage of the invention and should not be limited to the specific examples provided herein.

I claim:

1. A personal security alert system comprising:
a portable device having memory sufficient to retain personal data of a user, including at least one of the user's personal identification information, location information, health information, video, audio and environmental information,
the portable device being adapted to send and receive the information and having an eSIM card capable of communicating with a telecommunications network located in the United States and at least one other nation state;
a base station adapted to send information to, and receive information from, the portable device, and being configurable to monitor an alert condition indicated by at least one of a manual actuation of an alert switch actuated by the user and a sensed parameter automatically transmitted by the portable device, the alert condition being transmitted to the base station;
an application, loadable on a computer, and providing a user interface capable of making user settings and entering user personal data, the user settings including at least one of multiple call processing options, a primary emergency call location, a secondary emergency call location, a law enforcement call location, and a private security call location.

2. The personal security alert system of claim 1, wherein the portable device includes a substantially quadrilateral-shaped case having first and second spaced apart major surfaces, and a plurality of minor surface disposed between the first and second major surfaces, and defining an interior space, and an emergency alert actuator locate on one of the first and second major surfaces.

3. The personal security alert system of claim 1, further comprising at least one sensor capable of detecting a condition selected from the group consisting of the user's physical condition, a condition of the user's environment, and a physical force experienced by the user.

4. The personal alert system of claim 3, wherein the at least one sensor includes a first sensor for sensing at least one of the user's heart rate, blood oxygen, and blood sugar.

5. The personal alert system of claim 4, wherein the at least one sensor includes a second sensor for sensing the user's body temperature.

6. The personal alert system of claim 5, wherein the at least one sensor includes a third sensor for sensing ambient temperature.

7. The personal alert system of claim 6, wherein the at least one sensor includes a fourth sensor for sensing at least one of the user's acceleration, deceleration, gravitational force, and geospatial orientation.

8. The personal alert system of claim 3, wherein the alert switch comprises a button located on an exterior surface of the device and being configured to initiate alert responses when actuated by the user.

9. A method for requesting assistance comprising the steps of:
providing a monitoring device having a cellular radio transmitter;
storing information on the monitoring device selected from at least one of personal identification information, location information, health information, video, audio and environmental information;
activating the monitoring device, wherein the step of activating transmits the stored information to a third party; and
opening a direct line of communication with the third party using an eSIM card located in the monitoring device.

10. The method of claim 9, wherein the activing step includes at least one of manually pressing an alert button located on the monitoring device and automatically sensing an alert condition.

11. The method of claim 9, wherein the activing step includes both manually pressing an alert button located on the monitoring device and automatically sensing an alert condition.

12. The method of claim 10, wherein the step of automatically sensing an alert condition including sensing user physical parameters including heart rate and blood oxygen, and user acceleration, and wherein the activating step transmits stored data when a threshold sensed alert condition is reached.

13. A method for requesting assistance comprising the steps of:
providing a monitoring device having a cellular radio transmitter;
storing information on the monitoring device selected from at least one of personal identification information, location information, health information, video, audio and environmental information;
networking the monitoring device to a computing device having access to a network;
accessing one or more components of the computing device; and
transmitting the information stored on the monitoring device to a third party via the network accessible by the computing device.

14. A personal safety monitoring device, comprising:
a portable, handheld casing of generally elongated quadrilateral form having at least one activation switch easily accessible to a user;
a circuit board disposed inside the casing, and having at least an eSIM card to facilitate cellular communication in multiple coding formats, a GPS chip, and at least one sensor for detecting at least one of an environmental condition and a user condition;
a battery;
a speaker; and
a microphone.

15. The device of claim 14, wherein the at least one sensor includes an accelerometer.

16. The device of claim 15, wherein the at least one sensor further includes at least one of an ambient temperature sensor, a heart rate monitor, a blood oxygen monitor.
